(19) United States
(12) Patent Application Publication
(10) Pub. No.: US 2014/0064806 A1
(43) Pub. Date: Mar. 6, 2014

(54) IMAGE HEATING DEVICE

(71) Applicant: CANON KABUSHIKI KAISHA, Tokyo (JP)

(72) Inventor: Naoya Kikkawa, Tokyo (JP)

(73) Assignee: CANON KABUSHIKI KAISHA, Tokyo (JP)

(21) Appl. No.: 14/018,164

(22) Filed: Sep. 4, 2013

(30) Foreign Application Priority Data
Sep. 6, 2012 (JP) 2012-195677

(51) Int. Cl. G03G 15/20

(52) U.S. Cl. CPC G03G 15/2053
USPC 399/329

(57) ABSTRACT

An image heating device includes a rotatable heating member configured to heat a toner image formed on a sheet with a toner containing a wax component, an exciting coil arranged outside the rotatable heating member and configured to generate a magnetic flux for subjecting the rotatable heating member to electromagnetic induction heating, a holder configured to hold the exciting coil, a magnetic flux suppression member configured to suppress a portion of a magnetic flux that acts on the rotatable heating member from the exciting coil, and a movement mechanism configured to move the magnetic flux suppression member in a space between the rotatable heating member and the holder. The holder has a region opposite the magnetic flux suppression member, and the region is coated with fluorine-based resin.

### BACKGROUND OF THE INVENTION

1. Field of the Invention

The present disclosure relates to an image heating device that can be used in an image forming apparatus, such as, for example, a copying machine, a printer, a facsimile machine, and a multifunction peripheral.

2. Description of the Related Art

An image forming apparatus that forms an image using electrophotographic process or the like transfers a toner image formed by an image forming unit onto a recording material, and causes the recording material, onto which the toner image has been transferred, to be heated by a fixing device as an image heating device, thereby causing the toner image to be fixed onto the recording material.

Of such a fixing device, a configuration for arranging a coil unit that holds an exciting coil for performing electromagnetic induction, at a position in the proximity of the top of a fixing member (rotatable heating member) made of a thin-walled metal is discussed (see Japanese Patent Application Laid-Open No. 2007-78983).

However, as discussed in Japanese Patent Application Laid-Open No. 2007-78983, in the case of a structure where the coil unit is arranged in the proximity to the top of the fixing member, there is the following concern. When a recording material bearing an unfixed toner image thereon rushes into a nip portion during an image forming job, a wax component contained in the unfixed toner is evaporated and then remains between in the coil unit and the fixing member. Thereafter, the image forming job is completed, and the coil unit experiences drop in temperature, and as a result, an evaporated wax may possibly adhere to the fixing member. If such an adherence of the wax occurs, a magnetic flux suppression member, which is inserted into a slight space between the coil unit and the fixing member to change a magnetic flux density distribution caused by an exciting coil, may probably lead to failure in operation.

### SUMMARY OF THE INVENTION

The present disclosure is directed to an image heating device capable of reducing a failure in operation of a magnetic flux suppression member, which may be caused by wax contained in toner.

According to an aspect disclosed herein, an image heating device includes a rotatable heating member configured to heat a toner image formed on a sheet with a toner containing a wax component, an exciting coil arranged outside the rotatable heating member and configured to generate a magnetic flux for subjecting the rotatable heating member to electromagnetic induction heating, a holder configured to hold the exciting coil, a magnetic flux suppression member configured to suppress a portion of a magnetic flux that acts on the rotatable heating member from the exciting coil, and a movement mechanism configured to move the magnetic flux suppression member in a space between the rotatable heating member and the holder. The holder has a region opposite the magnetic flux suppression member, and the region is coated with fluorine-based resin.

Further features of the present invention will become apparent from the following description of exemplary embodiments with reference to the attached drawings.

### BRIEF DESCRIPTION OF THE DRAWINGS

FIG. 1 is a schematic configuration vertical sectional view of an image forming apparatus according to a first exemplary embodiment.

FIG. 2 is a schematic configuration transverse sectional view of a fixing device according to the first exemplary embodiment.

FIG. 3 is a layered structure view of a fixing belt.

FIG. 4 is a schematic configuration longitudinal sectional view of the fixing device.

FIG. 5 is a schematic configuration transverse sectional view of the fixing device illustrating a state where a magnetic flux shielding plate is inserted.

FIG. 6 is a schematic view of the fixing device as viewed from the front side.

FIG. 7 is a schematic view of the fixing device illustrating a portion covered with a coat material in the first exemplary embodiment.

FIG. 8 is a schematic view of a fixing device according to a second exemplary embodiment.

FIG. 9 is a flowchart illustrating an example of flow of control after completion of an image forming job in the second exemplary embodiment.

### DESCRIPTION OF THE EMBODIMENTS

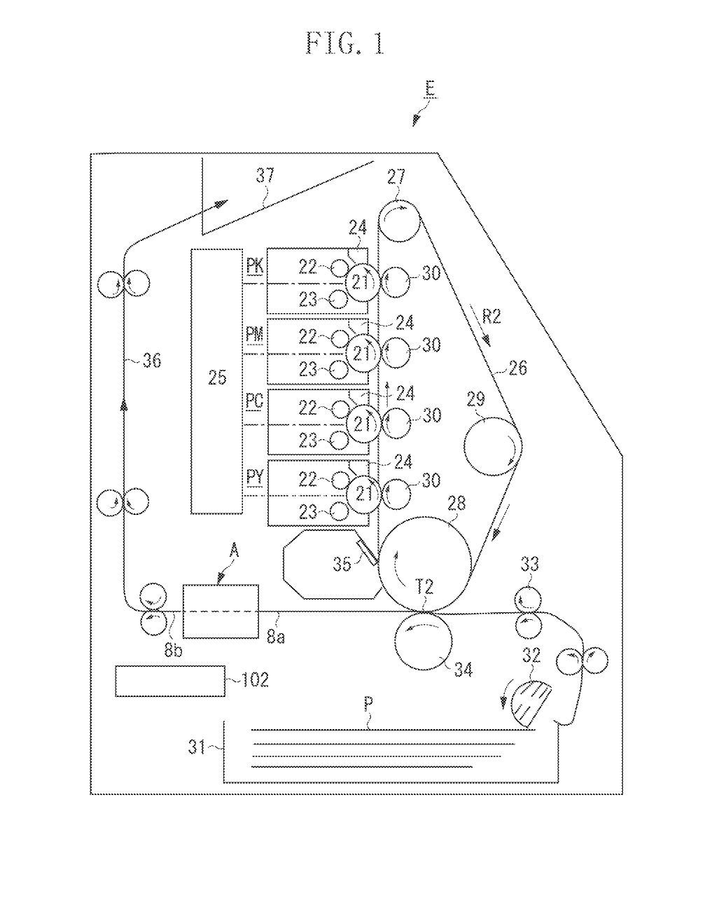

A first exemplary embodiment will be described with reference to FIG. 1 through FIG. 7. First, a schematic configuration of the image forming apparatus according to the present exemplary embodiment will be described with reference to FIG. 1.

[Image Forming Apparatus]

An image forming apparatus “E” illustrated in FIG. 1 is a color image forming apparatus employing an electrophotographic process. PY, PC, PM, and PK denote four image forming units that form color toner images of yellow, cyan, magenta, and black, respectively, and are arranged in this order from bottom to top of the figure. Each of the image forming units PY, PC, PM, and PK includes every one of photosensitive drums 21 as image bearing members, charging devices 22, developing devices 23, and cleaning devices 24.

Yellow toner is stored in the developing device 23 of the image forming unit PY, cyan toner is stored in the developing device 23 of the image forming unit PC, magenta toner is stored in the developing device 23 of the image forming unit PM, and black toner is stored in the developing device 23 of the image forming unit PK.

Further, an exposure device 25 that forms an electrostatic latent image by performing exposure onto the photosensitive drums 21 is provided in association with the image forming units PY, PC, PM, and PK for the above-described four colors. As the exposure device 25, a laser scanning exposure optical system is used.

In the image forming units PY, PC, PM, and PK, scanning exposure based on image data is performed onto the photosensitive drums 21 uniformly charged by the charging devices 22 from the exposure device 25. Accordingly, an electrostatic latent image corresponding to scanning exposure image pattern of each color is formed on a surface of each of the photosensitive drums 21 of the image forming units PY, PC, PM, and PK.

Then, these electrostatic latent images are developed as toner images by the developing devices 23. That is, yellow toner image is formed on the photosensitive drum 21 of the image forming unit PY, and cyan toner image is formed on the photosensitive drum 21 of the image forming unit PC. Further, magenta toner image is formed on the photosensitive drum 21 of the image forming unit PM, and black toner image is formed on the photosensitive drum 21 of the image forming unit PK.

Respective color toner images formed on the photosensitive drums 21 of the image forming units PY, PC, PM, and PK are primarily transferred in a superimposed manner in order in a predetermined positioning state onto an intermediate transfer belt 26 as an intermediate transfer member that circulates at a substantially equal speed, in synchronization with rotation of the photosensitive drums 21. This allows an unfixed full-color toner image to be combined and formed for four colors on the intermediate transfer belt 26. In the present exemplary embodiment, the intermediate transfer belt 26 is in the form of an endless belt, and is wound around three rollers: a drive roller 27, a secondary transfer counter roller 28, and a tension roller 29, and is stretched tightly by these rollers. Further, the intermediate transfer belt 26 is driven by the drive roller 27.

As a primary transfer unit of the toner image onto the intermediate transfer belt 26 from on the photosensitive drums 21 of the image forming units PY, PC, PM, and PK, a primary transfer roller 30 is used. A primary transfer bias with a reverse polarity to the toner is applied from a bias power source (not illustrated) to the primary transfer roller 30. This allows the toner image to be primarily transferred onto the intermediate transfer belt 26 from on the photosensitive drums 21 of the image forming units PY, PC, PM, and PK. After primary transfer from on the photosensitive drums 21 to the intermediate transfer belt 26 in the image forming units PY, PC, PM, and PK, the toner which has remained as residual transfer toner on the photosensitive drum 21 is removed by the cleaning devices 24.

By performing the process such as described above on respective colors of yellow, magenta, cyan, and black, in synchronization with circulation of the intermediate transfer belt 26, primary transfer toner images of respective colors are formed in a sequentially superimposed manner on the intermediate transfer belt 26. At the time of image formation of only single color (single color mode), the above-described process is performed on only a target color.

On the other hand, recording materials (sheets) P stored in a recording material cassette 31 are separated and fed in one-by-one fashion by a feed roller 32. Then, the recording material P is conveyed to a secondary transfer portion T2, which is a pressure-contact portion between the intermediate transfer belt 26 wound over the secondary transfer counter roller 28 and a secondary transfer roller 34, at a predetermined timing by registration rollers 33.

Primarily transferred and combined toner images formed on the intermediate transfer belt 26 are collectively transferred on the recording material P, by a bias with reverse polarity to the toner applied from the bias power source (not illustrated) to the secondary transfer roller 34. The secondary transfer residual toners which have remained on the intermediate transfer belt 26 after the secondary transfer are removed by an intermediate transfer belt cleaning device 35.

The toner image secondarily transferred onto the recording material P are fused, color-mixed, and fixed onto the recording material P by the fixing device “A” as an image heating device, and is sent out to a sheet discharge tray 37 through a sheet discharge path 36 as a full-color print.

[Fixing Device]

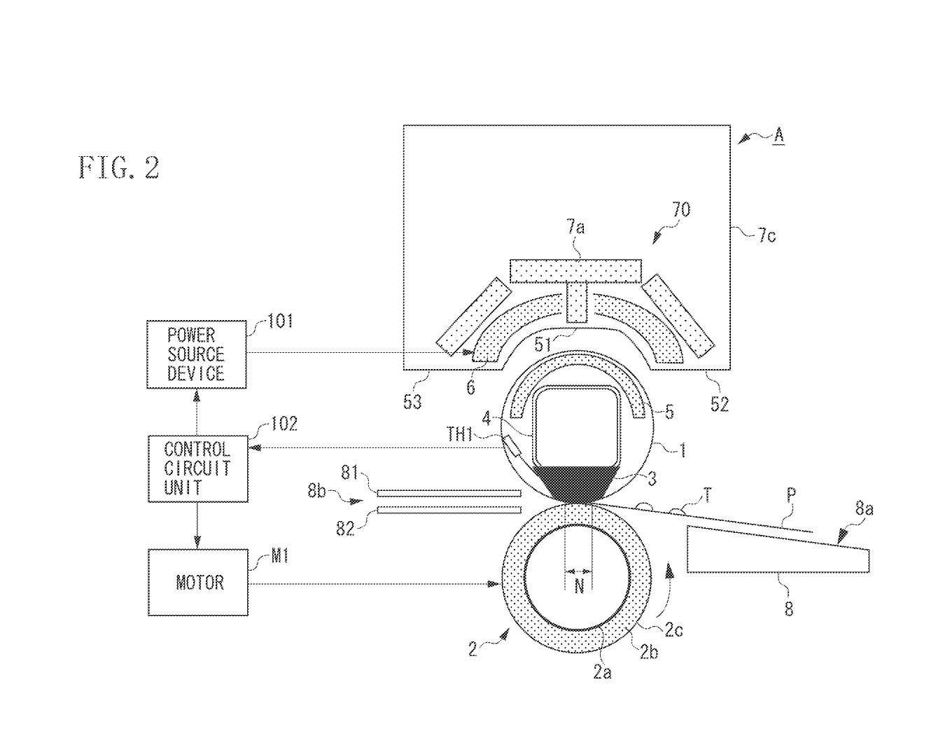

Next, the above fixing device “A” will be described with reference to FIG. 2 through FIG. 7. In the following descriptions, the longitudinal direction (widthwise direction) of the fixing device or members that constitute the fixing device refers to a direction orthogonal to the recording material conveyance direction within a recording material conveyance path plane. The lateral direction is a direction parallel to the recording material conveyance direction. With respect to the fixing device, the front surface refers to a surface as viewed from a recording material entrance side, the rear surface is a surface on the opposite side to the front surface (as seen from a recording material exit side), and the left (side) and the right (side) of the fixing device refer to left (side) and right (side) as viewed from the front surface side. The upstream side and downstream side refer to an upstream side or a downstream side with respect to the recording material conveyance direction

The fixing device “A”, as illustrated in FIG. 2, includes a fixing belt 1 as a rotatable heating member, a pressure roller 2 as a nip forming member (rotatable driving member), and an induction heating device 70 as a magnetic flux generating unit. The fixing belt 1 is composed of an endless belt having a metal layer. The pressure roller 2 is a rotatable pressing member disposed to come into contact with an outer periphery of the fixing belt 1.

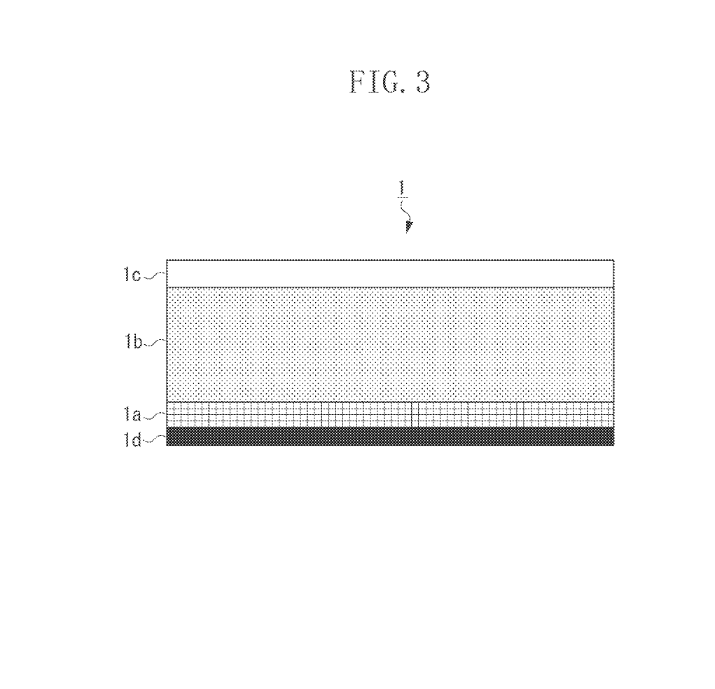

The fixing belt 1, as illustrated in FIG. 3, includes a base layer (metal layer) 1a made of nickel, which is 30 mm in an inner diameter, for example, and is manufactured by an electroforming method. The thickness of the base layer 1a is 40 μm. A heat-resistant silicone rubber layer is provided as an elastic layer 1b on the outer periphery of the base layer 1a. It is desirable to set the thickness of the silicone rubber layer within a range of 100 μm to 1000 μm. In the present exemplary embodiment, in consideration of making a heat capacity of the fixing belt 1 small to shorten a warming-up time, and obtaining suitable fixed images when fixing color images, the thickness of the silicone rubber layer is set to 300 μm. The silicone rubber has a hardness of JIS-A20 degrees, and a thermal conductivity of 0.8 W/mK. Furthermore, on the outer periphery of the elastic layer 1b, a fluorine resin layer (for example, PFA or PTFE) is provided, which has a thickness of 30 μm as a surface release layer 1c.

On the inner surface side of the base layer 1a, in order to reduce sliding friction between an inner surface of the fixing belt and a temperature sensor TH1 (FIG. 2) described below, a resin layer (lubrication layer) 1d such as the fluorine resin or the polyimide may be provided 10 to 50 μm thick. In the present exemplary embodiment, the polyimide layer as the layer 1d is provided 20 μm thick.

For the base layer 1a of the fixing belt 1, other metals such as ferrous alloy, copper, silver, in addition to nickel can be selected appropriately. Further, these metal layers may be laminated on the resin base layer. The thickness of the base layer 1a may be adjusted according to a frequency of high-frequency current which is made to flow through the exciting coil, which will be described below, and a magnetic permeability and a conductivity of the metal layer, and the thickness may be set between about 5 μm and 200 μm.

The pressure roller 2, as illustrated in FIG. 2, for example, has an outer diameter of 30 mm, and includes a cored bar 2a made of ferrous alloy, with a diameter of 20 mm in central portion in a longitudinal direction and a diameter of 19 mm at both end portions, and a silicone rubber layer provided thereon as an elastic layer 2b. The surface is provided with the fluorine resin layer (for example, PFA or PTFE) with a thickness of 30 μm as a surface release layer 2c. The hardness of the central portion in the longitudinal direction of the pressure roller 2 is ASK-C70 degrees. The reason why the cored bar 2a is formed in a tapered shape is because a pressure inside the fixing nip that is nipped by the fixing belt 1 and the pressure roller 2 is to be made uniform extending in the longitudinal direction, even when a pressure imparting member 3 described below is deflected when pressurized.

The widths in a rotating direction of the fixing nip portion N between the fixing belt 1 and the pressure roller 2 in the present exemplary embodiment are about 9 mm at both longitudinal end portions, and about 8.5 mm in the central portion, in a fixing nip pressure of 600 N. This has the advantage that paper warping is unlikely to occur because a conveyance speed at both end portions of the recording material P become faster than in the central portion.

Further, inside the fixing belt 1, the pressure imparting member 3 which forms the fixing nip portion N by causing a pressing force to act between the fixing belt 1 and the pressure roller 2 is arranged in the longitudinal direction. The pressure imparting member 3 is held by a stay 4 made of metal disposed in the longitudinal direction. On the induction heating device 70 side of the stay 4, there is provided a magnetic shielding core 5 as a magnetic shielding member for preventing temperature rise by induction heating.

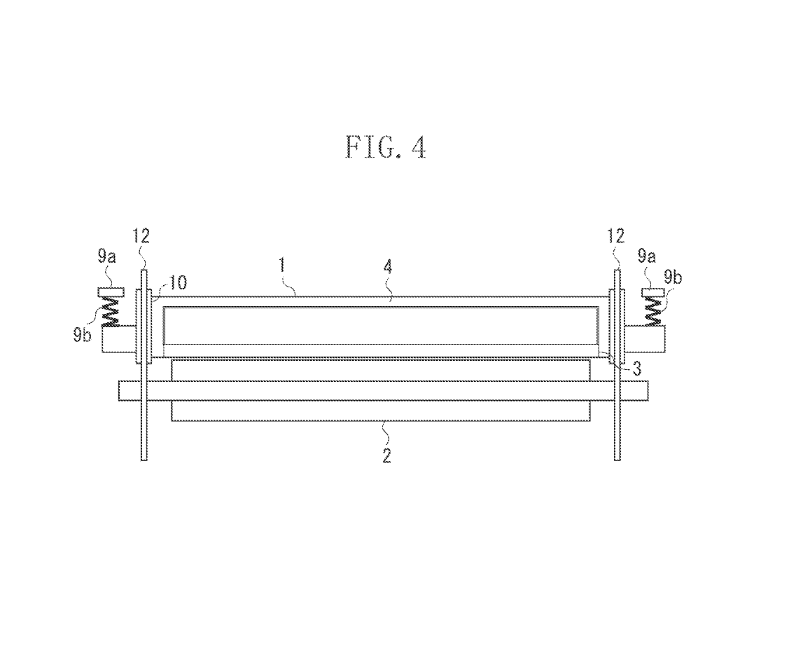

Such the stay 4 is supported at both longitudinal end portions, by fixing flanges 10 illustrated in FIG. 4. The fixing flanges 10 are arranged at both end portions of the fixing belt 1, as a regulating member that regulates a longitudinal movement and a circumferential shape of the fixing belt 1. Supporting side plates 12 are used to support the fixing belt 1, and the fixing flanges 10 are supported by the supporting side plates 12. Then, a longitudinal position of the fixing belt 1 is regulated, via the fixing flanges 10, by the supporting side plates 12. The fixing belt 1, which is rotatable, has the base layer formed of metal. Consequently, as a method for regulating a displacement in the widthwise direction even in a rotating state, provision of the fixing flanges 10 enough to simply receive end portions of the fixing belt 1 should be sufficient, and there is an advantage that this enables the configuration of the fixing device to be simplified.

Further, by compressingly providing stay pressing springs 9b between both end portions of the stay 4 insertedly disposed inside the fixing flanges 10, and spring receiving members 9a on device chassis side, a force directed toward the pressure roller 2 is caused to act on the stay 4. This brings the pressure imparting member 3 and the outer peripheral surface of the pressure roller 2 into press-contact with each other while interposing the fixing belt 1 therebetween, thereby forming the fixing nip portion N with a predetermined width.

The pressure imparting member 3 is made of heat-resistant resin, and the stay 4 is made of iron in the present exemplary embodiment, since it requires rigidity to apply pressure to the press-contact portion. Further, the pressure imparting member 3 comes close to an exciting coil 6 described below especially at both end portions, and a magnetic shielding core 5 is arranged extending in the longitudinal direction on the top surface of the pressure imparting member 3, in order to shield against the magnetic fields generated from the exciting coil 6 to prevent heat generation of the pressure imparting member 3.

The induction heating device 70 is a heating source (induction heating unit) that heats the fixing belt 1 through an electromagnetic induction (IH). The induction heating device 70 includes the exciting coil 6 and outer magnetic cores 7a. The exciting coil 6 uses, e.g., Litz wire as an electric wire, and is prepared by winding the Litz wire in an elongated ship's bottom-like shape so that the exciting coil 6 is located opposite a part of the peripheral surface and side surfaces of the fixing belt 1. The outer magnetic cores 7a are arranged to cover the exciting coil 6 so that magnetic fields generated by the exciting coil 6 do not substantially leak to other than the metal layer (electrically conductive layer) of the fixing belt 1. The exciting coil 6 and the outer magnetic cores 7a with such configurations are supported by an electrical insulating resin by a mold member 7c. That is, the induction heating device 70 as a magnetic flux generating unit is arranged inside the mold member 7c. The magnetic flux generated by the exciting coil 6 is directed to the fixing belt 1 by the outer magnetic cores 7a, and the fixing belt 1 produces heat due to passage of the magnetic flux. In the present exemplary embodiment, the mold member 7c corresponds to a case member (a holder) arranged above the fixing belt 1 in a gravity direction.

The induction heating device 70 with such a configuration is disposed facing the fixing belt 1 with the presence of a predetermined gap (clearance), above the outer peripheral surface of the fixing belt 1. Further, the outer magnetic cores 7a is divided into a plurality of parts in a longitudinal direction and arranged in a row, and a plurality of magnetic cores arranged at both longitudinal end sides is arranged to be freely movable far or near, relative to the fixing belt 1. Then, in a non-sheet-passing part not allowing the recording material to pass through with respect to the longitudinal direction of the fixing nip portion N, the clearance between the fixing belt 1 and the outer magnetic cores 7a is widened, so that a magnetic flux density passing through the fixing belt 1 be decreased, and thereby a heat quantity of the fixing belt 1 be lowered.

The configuration of the induction heating device 70 will be described more specifically. In the present exemplary embodiment, the fixing belt 1 and the exciting coil 6 in the induction heating device 70 are kept in an electrically insulating state by a mold having a thickness of 0.5 mm. A spacing between the fixing belt 1 and the exciting coil 6 is constant at 1.5 mm (i.e., a distance between mold surface and fixing belt surface is 1.0 mm), and thus the fixing belt 1 is uniformly heated.

A high-frequency current of 20 kHz to 50 kHz is applied to the exciting coil 6, so that the base layer 1a of the fixing belt 1 is induction-heated. Then, temperature adjustment is performed by controlling an electric power to be input into the exciting coil 6 by altering a frequency of high-frequency current based on a detection value of the temperature sensor TH1, so that the temperature of the fixing belt 1 becomes constant at 180° C., which is the target temperature of the fixing belt 1.

More specifically, in the rotation state of the fixing belt 1, to the exciting coil 6 of the induction heating device 70, a high-frequency current of 20 kHz to 50 kHz is applied from the power source device (exciting circuit) 101. Then, the metal layer (electrically conductive layer) of the fixing belt 1 is induction-heated by magnetic field generated by the exciting coil 6. The temperature sensor TH1 is a temperature detecting element (e.g., a thermistor), and is disposed at a position of widthwise central and inner surface portion of the fixing belt 1 in contact to the fixing belt 1. Specifically, the temperature sensor TH1 is mounted on the pressure imparting member 3 via an elastic supporting member and, therefore, even when positional fluctuation such as undulating (waving) of a contact surface of the fixing belt 1 is generated, the temperature sensor TH1 follows the positional fluctuation and is kept in a good contact state to the fixing belt.

The temperature sensor TH1 detects the temperature of a portion of the fixing belt 1 which becomes a sheet-passing part of the recording material, so that detected temperature information is fed back to a control circuit unit 102 as a control unit. The control circuit unit 102 controls an electric power supplied from a power source device 101 to the exciting coil 6 so that the detected temperature input from the temperature sensor TH1 is kept at a predetermined target temperature (fixing temperature). That is, the control circuit unit 102 interrupts energization to the exciting coil 6 when the detected temperature of the fixing belt is increased up to the predetermined temperature. In the present exemplary embodiment, the control circuit unit 102 changes the frequency of the high-frequency current based on a detected value of the temperature sensor TH1, so that the detected temperature of the fixing belt 1 is constant at 180° C. as the target temperature of the fixing belt 1, by controlling an electric power input into the exciting coil 6 to perform temperature adjustment.

In the present exemplary embodiment, the induction heating device 70 including the exciting coil 6 is not disposed inside the fixing belt 1, which may be heated to high temperature, but is disposed outside the fixing belt 1. Consequently, the temperature of the exciting coil 6 is not readily increased to high temperature. Further, also an electric resistance is not increased, so that even when the high-frequency current passes through the exciting coil 6, it becomes possible to alleviate loss caused by Joule heating. Further, externally arranging the exciting coil 6 contributes to a smaller diameter (lower thermal capacity) of the fixing belt 1, and furthermore it can be said that the induction heating device 70 is excellent in energy-saving property. With respect to a warming-up time of the fixing device “A” according to the present exemplary embodiment, a configuration in which the thermal capacity is very low is employed, and, therefore, when, for example, 1200 W is input into the exciting coil 6, the temperature of the fixing device “A” can reach 180° C. as the target temperature in about 15 seconds. There is no need to perform a heating operation during standby, and, therefore, power consumption can be reduced to a very low level.

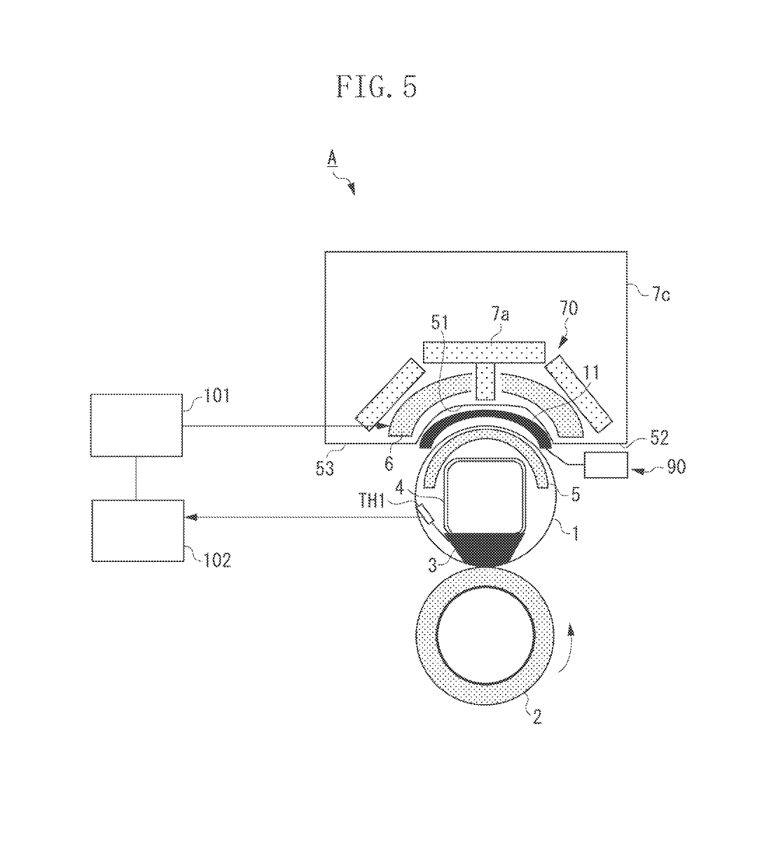

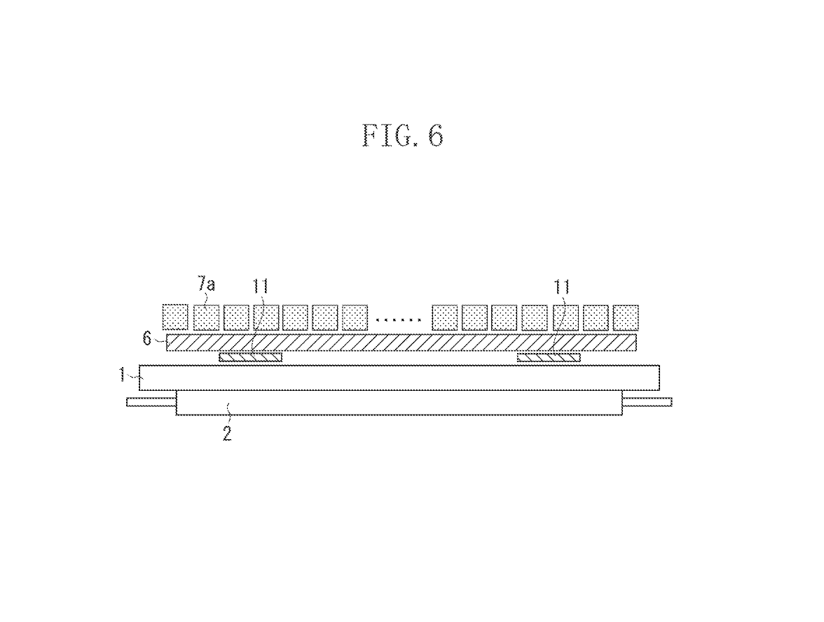

Further, in a case of the present exemplary embodiment, as illustrated in FIG. 5 and FIG. 6, the fixing device includes a magnetic flux shielding plate 11 as a magnetic flux suppression member that is provided to freely enter a space between the induction heating device 70 and the fixing belt 1, and adjusts magnetic fluxes flowing through the fixing belt 1 from the induction heating device 70. The magnetic flux shielding plate 11 is made of a material such as non-magnetic metal such as aluminum, copper, silver, gold, or brass, or its alloy or ferrite or permalloy as a high-permeability member, and reduces or shuts off the passage through a part of the fixing belt 1 by magnetic fluxes generated by the exciting coil 6.

The magnetic flux shielding plate 11 is freely movable in the longitudinal direction so as to be freely able to enter a space between a part of the mold member 7c that supports the induction heating device 70 and the fixing belt 1, by a movement mechanism 90 composed of a motor and a belt. That is, the magnetic flux shielding plate 11 is allowed to enter a space between portions nearer to both longitudinal ends of the opposite surface 51 of the mold member 7c opposite the outer peripheral surface of the fixing belt 1 and the fixing belt 1, and to retract from the space therebetween. Then, as illustrated in FIG. 6, temperature rise at a non-sheet-passing part can be inhibited, by moving the magnetic flux shielding plate 11 in response to sizes of various types of recording materials (e.g., postcard, A5, B4, A4, A3 Nobi sizes), and weakening magnetic flux density passing through the fixing belt 1. The magnetic flux shielding plate 11 is moved while sliding relative to a part of the mold member 7c (the opposite surface 51 in FIG. 2).

The fixing belt 1 is dependently rotated, by rotationally driving the pressure roller 2 by a motor (driving unit) M1 controlled by the control circuit unit 102, at least at the time of executing image formation. Then, the recording material P is conveyed through a conveyance path 8a from the secondary transfer portion T2 side (upstream side of the recording material conveyance direction) in FIG. 1. At that time, the fixing belt 1 is rotationally driven at substantially the same circumferential speed as a conveyance speed of the recording material P bearing the unfixed toner image T thereon. In the case of the present exemplary embodiment, the fixing belt 1 rotates at a surface rotational speed of 300 mm/sec, thus enabling a full-color image to be fixed on the recording material at a rate of 80 sheets/min for A4 size, and 58 sheets/min for A4R size.

The recording material P bearing the unfixed toner image T thereon, as illustrated in FIG. 2, is guided by a guide member 8 with its toner image bearing surface side facing toward the fixing belt 1 side, and is introduced to the fixing nip portion N. That is, in the conveyance path 8a on an upstream side of the recording material conveyance direction of the fixing nip portion N, there is provided the guide member 8 as an upstream side guide member, arranged below the recording material P, which guides the recording material to the fixing nip portion N. Then, the recording material P closely contacts the outer peripheral surface of the fixing belt 1 in the fixing nip portion N, and is pinched and conveyed in the fixing nip portion N together with the fixing belt 1. Accordingly, the unfixed toner image T receives a pressing force of the fixing nip portion N under application of mainly the heat of the fixing belt 1, thus being fixed under heating and pressuring condition onto the surface of the recording material P.

The recording material P having passed through the fixing nip portion N is self-separated from the outer peripheral surface of the fixing belt 1 since the surface of the fixing belt 1 is deformed at an exit portion of the fixing nip portion N, and then is conveyed to the outside of the fixing device. In a conveyance path 8b on a downstream side of the recording material conveyance direction of the fixing nip portion N, a pair of guide plates 81 and 82 as a downstream side guide member that guides the recording material P discharged from the fixing nip portion N are arranged, on the upper side and on the lower side of the recording material P. The recording material P, which has come out of the fixing nip portion N, is conveyed to a sheet discharge path 36, after passing between the guide plates 81 and 82. A plurality of through-holes is formed, in these guide plates 81 and 82, which is adapted to allow water content to be eliminated when the recording material P is heated to be drained therethrough. For example, at the time of start-up of the image forming apparatus, image formation may be started while temperature within the apparatus is low. In such a case, this reduces condensation of the water content drained from the recording material, in between guide plates 81 and 82.

[Reduction of Adherence of Wax]

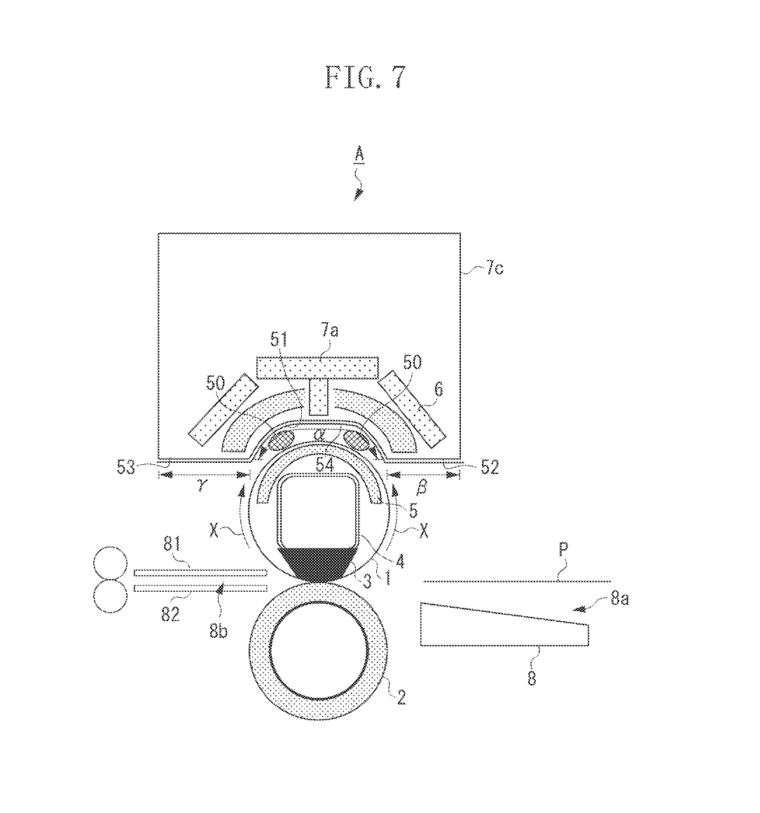

In the present exemplary embodiment, the recording material P, on which the unfixed toner image T is borne, is fixed and output, through the configuration as described above, but at that time, a wax component contained in toner evaporates at the fixing nip portion N. As illustrated in FIG. 7, evaporated wax components 50 move upward as a function of density, as indicated by an arrow X, and a part of the evaporated wax components remains on the surface on the fixing belt 1 side of the mold member 7c, which supports the induction heating device 70. When the temperature of the surface of the mold member 7c drops as it is, there is concern that the wax may adhere to the surface.

Thus, in the present exemplary embodiment, the surface on the fixing belt 1 side of the mold member 7c is covered with a coat material 54. In the present exemplary embodiment, the coat material 54 is covered with fluorine coat having a contact angle with water of 84° or greater. Specifically, of the surfaces of the mold member 7c, the total extent of the opposite surface 51 existing in a region a opposite the fixing belt 1, and the opposite surfaces 52 and 53 each existing in regions β and γ opposite the conveyance paths 8a and 8b of the recording material (sheet) P is covered with the coat material 54. As a method for covering the opposite surfaces 51 through 53 with the coat material 54, for example, a method for heating (burning) by spraying the coat material onto the opposite surfaces 51 through 53 is taken.

Further, such coat materials include tetrafluoroethylene-perfluoroalkyl vinyl ether copolymer and the like, and especially, it is desirable to use the one with a contact angle with water of 84° or greater. In the present exemplary embodiment, polytetrafluoroethylene (PTFE) is used as a coat material. Further, as coat materials, besides this, various types of fluorine-based resins such as for example, PFA, FEP, ETFE, and PCTFE, can be used. From the viewpoint of increasing mass productivity, it is desirable to use the one with a contact angle of 170° or less.

In the case of the present exemplary embodiment, of the surfaces of the mold member 7c that support the induction heating device 70 arranged above the fixing belt 1, the opposite surfaces 51 through 53 opposite the fixing belt 1 and the conveyance paths 8a and 8b are covered with the coat material 54 with a contact angle with water of 84° or greater. For this reason, a wax component of the toner evaporated at the fixing nip portion N becomes unlikely to adhere to the opposite surfaces 51 through 53 of the surfaces of the mold member 7c, and thereby the wax can be made unlikely to adhere to the opposite surfaces 51 through 53.

In particular, in the case of a configuration for heating the fixing belt 1 by using the induction heating device 70, as in the present exemplary embodiment, a clearance between the fixing belt 1 and the induction heating device 70 becomes narrow. For example, in the present exemplary embodiment, since the magnetic flux shielding plate 11 is present, the clearance is set to 2 mm. However, if the magnetic flux shielding plate 11 is absent, the clearance may be, for example, about 1 mm in some cases. Consequently, the wax component is likely to remain between the fixing belt 1 and the induction heating device 70, and the adherence of the wax occurs readily. Consequently, as in the present exemplary embodiment, even in a structure using the induction heating device 70, the occurrence of adherence of the wax can be reduced by covering the surfaces of the mold member 7c with the coat material 54.

This results in preventing the adhered wax from being liquefied and dropping onto the recording material P conveyed to the fixing belt 1 or the conveyance paths 8a and 8b to thereby cause faulty images. That is, when the wax adheres to the fixing belt 1, there is a possibility that it exerts an influence on images which are heated and fixed at the fixing nip portion N. Further, even when the wax adheres to the recording material P to be conveyed to the conveyance paths 8a and 8b, it may exert an influence on images on the recording materials.

In the case of the present exemplary embodiment, in the conveyance path 8a on the upstream side of the fixing nip portion N, the guide member 8 is arranged below the recording material P, and there is no blocking member between the mold member 7c and the recording material P in the conveyance path 8a. Consequently, if the wax having adhered to the mold member 7c is liquefied and drops, there is a possibility that the wax directly hits the recording material P in the conveyance path 8a. On the other hand, since the recording material P passes between a pair of the guide plates 81 and 82, in the conveyance path 8b on the downstream side of the fixing nip portion N, it means that the guide plate 81 is present between the mold member 7c and the recording material P in the conveyance path 8b. Therefore, when the wax is liquefied and drops in the conveyance path 8b, it hits the guide plate 81. However, as described above, since a plurality of through-holes is formed on a pair of the guide plates 81 and 82 to be arranged to the conveyance path 8b, there is a possibility that the dropped wax hits the recording material P within the guide plates 81 and 82 through the through-holes. Therefore, in the present exemplary embodiment, of the surfaces of the mold member 7c, it is so configured as to cover the opposite surface 53 opposite the conveyance path 8b with the coat material 54, in addition to the opposite surface 51 opposite the fixing belt 1 and the opposite surface 52 opposite the conveyance path 8a.

As described above, the magnetic flux shielding plate 11 is arranged in a freely movable fashion between the mold member 7c and the fixing belt 1. Therefore, of the surfaces of the mold member 7c, if the wax adheres to a region where the magnetic flux shielding plate 11 moves, there is a possibility that movement of the magnetic flux shielding plate 11 cannot be smoothly performed. In the present exemplary embodiment, since the opposite surfaces 51 through 53 of the surfaces of the mold member 7c are covered with the coat material 54, the wax is unlikely to adhere to the region where the magnetic flux shielding plate 11 moves. As a result, disabling smooth movement of the magnetic flux shielding plate 11 due to an adherence of the wax can be prevented. In other words, the movement of the magnetic flux shielding plate 11 can be smoothly performed over a long period of time.

[Experiment]

An experiment performed to confirm such effect of the present exemplary embodiment will be described. In the experiment, the surfaces of the mold member 7c are covered with various types of coat materials, as illustrated in Table 1 described below, and respective adherence statuses of waxes are investigated. The experiment was conducted by investigating adherence statuses of the waxes to the surfaces of the mold member 7c, after passing 300,000 sheets of plain paper with a grammage of 80 g/m², and an image ratio 10%. The condition is set assuming use conditions in an ordinary office environment. Table 1 indicates results of contact angles with water and adherence statuses of the waxes and various types of coat materials.

TABLE 1

| Coat | Contact Angle With | Adherence Status |
|---|---|---|
| Material | Water | of Wax |
| PTFE | 110° | ◯ |
| PFA | 115° | ◯ |
| FEP | 114° | ◯ |
| ETFE | 96° | ◯ |
| PCTFE | 84° | Δ |
| Nylon | 77° | X |
| Phenol | 60° | X |
| Resin | | |

Circle mark in the Table 1 indicates a case where an amount of adhered wax was small or little, and faulty image or malfunction of the magnetic flux shielding plate 11 did not occur. Triangle mark indicates a case where adherence of wax is occurring, but defective image or malfunction of the magnetic flux shielding plate 11 has not occurred. Cross mark indicates a case where an amount of adhered wax was large.

As it is apparent from Table 1, it is found that, if a contact angle with water of the coat material is 84° or greater, defective image or malfunction of the magnetic flux shielding plate 11 due to adherence of the wax does not occur. Further, it is found that, if a contact angle with water of the coat material is 96° or greater, amount of adhered wax can be more suppressed. Since there are some cases where many images with high image ratios are formed, depending of a user's usage status, it is desirable to set the contact angle with water of the coat material to 96° or greater, in order to prevent more surely adherence of the wax.

The portions to be covered with the coat material 54 may be at least a part of portions opposite the fixing belt 1 and the conveyance paths 8a and 8b, of the surfaces of the mold member 7c. As described above, in the case of the present exemplary embodiment, in the conveyance path 8a on the upstream side of the fixing nip portion N, there is no blocking member between the mold member 7c and the recording material P. On the other hand, in the conveyance path 8b on the downstream side of the fixing nip portion N, the guide plate 81 is present between the mold member 7c and the recording material P. Consequently, in the conveyance path 8a, if the wax which has adhered to the mold member 7c drops after being liquefied, there is a possibility that the wax directly hits the recording material P, but in conveyance path 8b, the wax hits the guide plate 81. Therefore, the coat material 54 may cover the portions opposite the fixing belt 1 and the conveyance path 8a on the recording material conveyance direction upstream side of the fixing nip portion N, of the surfaces of the mold member 7c. That is, of the surfaces of the mold member 7c, the opposite surface 51 that is present in a region a opposite the fixing belt 1, and the opposite surface 52 that is present in a region β opposite the conveyance path 8a may be covered with the coat material 54. In that case, the opposite surface 53 that is present in a region γ opposite the conveyance path 8b is not covered with the coat material.

In the case where a blocking member is provided between the conveyance paths 8a and 8b and the mold member 7c, only the opposite surface 51 opposite the fixing belt 1 may be covered with the coat material 54. In that case, since the magnetic flux shielding plate 11 moves at both longitudinal end sides of the opposite surface 51, at least a region where the magnetic flux shielding plate 11 moves is covered with the coat material 54.

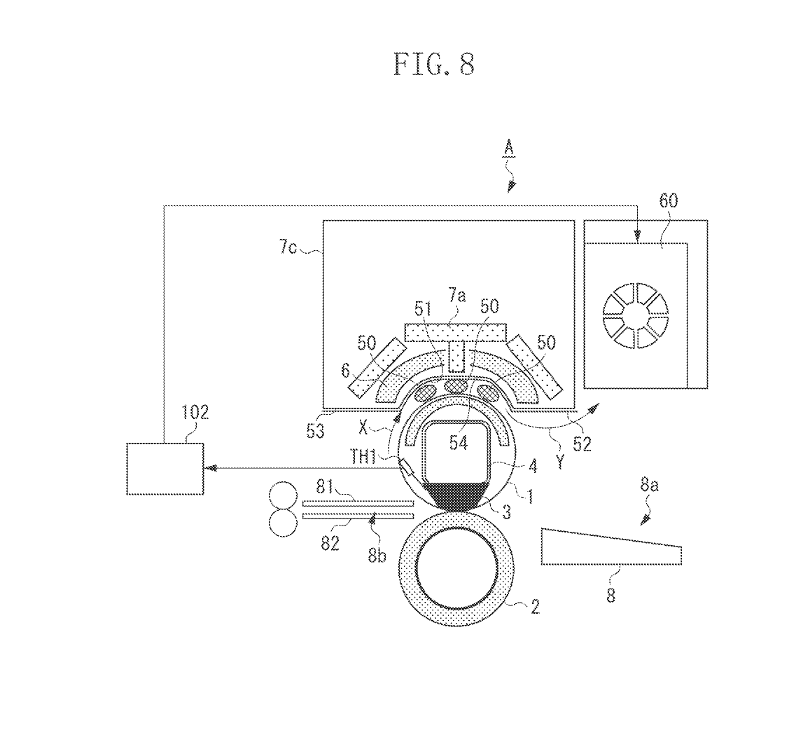

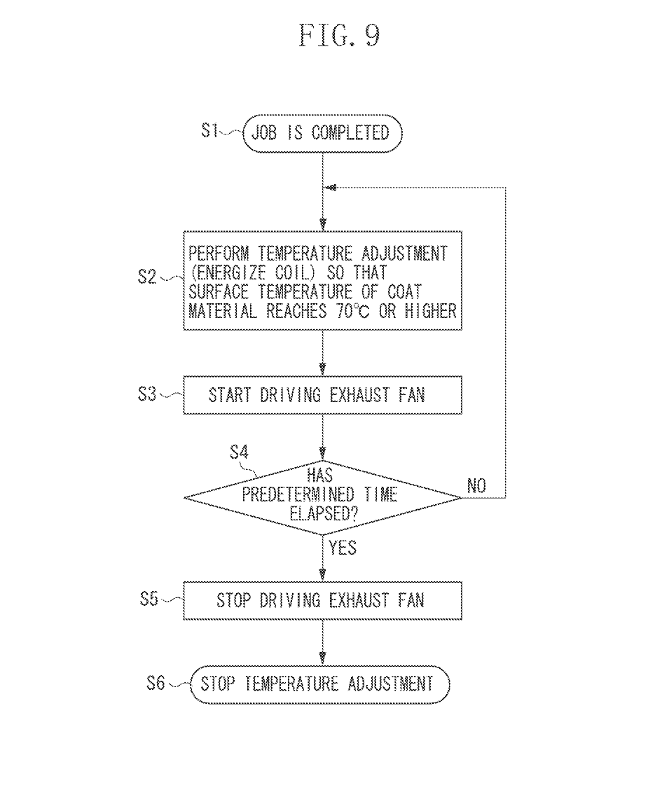

A second exemplary embodiment will be described with reference to FIG. 8 and FIG. 9. In the case of the present exemplary embodiment, similarly to the first exemplary embodiment, the opposite surfaces 51 through 53 of the surfaces of the mold member 7c arranged on the upper side of the fixing belt 1 are covered with the coat material 54. However, in the present exemplary embodiment, the fixing device has an exhaust fan 60 as an exhaust unit that exhausts air around the fixing belt 1. The exhaust fan 60 is a fan to discharge heat of the fixing device “A”, typically provided on a main body of the image forming apparatus “E”. Separately, a dedicated fan may be provided.

At any rate, the exhaust fan 60 is provided on a side plate that constitutes a housing of the main body of the image forming apparatus “E”, and a duct is disposed to the vicinity of the fixing device “A” from the exhaust fan 60. Then, air around the fixing device “A”, and furthermore, air around the fixing belt 1 is discharged to the outside of the main body of the image forming apparatus “E” by the exhaust fan 60 via the duct. It is desirable to arrange the exhaust fan 60 above the surface on the fixing belt 1 side of the mold member 7c.

In the present exemplary embodiment, as illustrated in FIG. 8, the exhaust fan 60 is installed on the recording material conveyance direction upstream side of the fixing device “A”, and air around the fixing belt 1 flows to the recording material conveyance direction upstream side of the fixing nip portion N, as indicated by an arrow “Y”. This enables the wax components 50 of the evaporated toner that exists around the fixing belt 1 to be suctioned out by the exhaust fan 60. On the upstream side of the exhaust fan 60, a filter is provided, and the wax components 50 which have been suctioned out by the exhaust fan 60 are trapped.

For example, in a case where a lot of images with high image ratio are output, an amount of produced wax can be higher in direct proportion. For this reason, in the present exemplary embodiment, the wax components 50 which have remained in a gaseous state are suctioned out by driving the exhaust fan 60 after completion of the image forming job, to make the wax unlikely to adhere to the surfaces of the mold member 7c.

Further, in the case of the present exemplary embodiment, the control circuit unit 102 as a control unit controls driving of the exhaust fan 60 in addition to temperatures of the fixing belt 1. Then, the control circuit unit 102 controls the temperature of the fixing belt 1 after completion of the image forming job so that the surface temperature of the mold member 7c becomes equal to or higher than the vaporization temperature of the wax contained in the toner, and drives the exhaust fan 60 for a predetermined time.

That is, in the present exemplary embodiment, the control circuit unit 102 drives the exhaust fan 60, after completion of the image formatting job, to exhaust the wax components 50 around the fixing belt 1. At that time, when heating of the fixing belt 1 is completed, the temperature of the mold member 7c becomes low, and there is a possibility that the adherence of the wax will begin even when the exhaust fan 60 is being driving. Thus, in the present exemplary embodiment, by performing heating of the fixing belt 1 even after completion of the image forming job, and keeping the surface temperature of the coat material 54 equal to or higher than the vaporization temperature of the wax contained in the toner, the wax is kept as evaporated or is evaporated. Then, driving the exhaust fan 60 for a predetermined time enables the evaporated wax to be discharged. In a case where the exhaust fan 60 is driven even while the image forming job is in progress, the exhaust fan 60 continues to be driven for a predetermined time even after the image forming job is completed.

The predetermined time during which the exhaust fan 60 is to be driven is defined as a time during which the wax around the fixing belt 1 is sufficiently discharged, which is to be determined in advance by experiment or the like. In the present exemplary embodiment, the time is set at 30 seconds. Further, the predetermined time may be varied depending on image forming conditions, for example, the temperature within the apparatus, the number of image formations, and the image ratio. For example, if images with greater image ratio are output in a larger number, the predetermined time is set longer.

Further, the temperature of the fixing belt 1 after completion of the image forming job is set lower than a temperature at the time of execution of the image forming job. For example, if the same high temperature as at the time of execution of the image forming job is maintained even after completion of the image forming job, there is a possibility that a lifetime of the fixing belt 1 or the pressure roller 2 may be decreased. Consequently, in the present exemplary embodiment, the temperature of the fixing belt 1 is made lower than the temperature at the time of execution of the image forming job, and the surface temperature of the coat material 54 is made equal to or higher than the vaporization temperature of the wax contained in the toner. Specifically, since the vaporization temperature of the wax of the toner of the present exemplary embodiment is 70°, the surface temperature of the coat material 54 is set to 70° or higher. This allows efficient exhaust of the wax to be performed by the exhaust fan 60, while inhibiting a lifetime decrease of the fixing belt 1 or the pressure roller 2.

The flow of such control will be described with reference to FIG. 9. First, in step S1, the image forming job is completed. In step S2, the control circuit unit 102 performs temperature adjustment of the fixing belt 1 to the predetermined temperature, so that the surface temperature of the coat material 54, which covers the surfaces of the mold member 7c, reaches 70° or higher. That is, the control circuit unit 102 controls the induction heating device 70 (FIG. 2) based on detection of the temperature sensor TH1, and adjusts the temperature of the fixing belt 1 to the predetermined temperature. Then, in step S3, the control circuit unit 102 drives the exhaust fan 60 for a predetermined time. In step S4, when the control circuit unit 102 has finished driving the exhaust fan 60 for the predetermined time, then in step S5, the control circuit unit 102 stops driving the exhaust fan 60, and then in step S6, ends temperature adjustment of the fixing belt 1.

In the case of the present exemplary embodiment, the opposite surfaces 51 through 53 of the mold member 7c are covered with the coat material 54, and the temperature of the fixing belt 1 is adjusted to the predetermined temperature, after completion of the image forming job, and exhaust by the exhaust fan 60 is performed. Accordingly, the wax adhering to the surfaces of the mold member 7c located on the upper side of the fixing belt 1 can be reduced more effectively.

In the present exemplary embodiment, the whole of the opposite surfaces 51 through 53 of the mold member 7c is covered with the coat material 54, but the portions covered with the coat material 54 may be only the opposite surfaces 51 and the opposite surface 52. That is, in the case of the present exemplary embodiment, employed is a configuration for suctioning out air around the fixing belt 1 toward the recording material conveyance direction upstream side of the fixing nip portion N by the exhaust fan 60. Accordingly, the wax is likely to adhere to the opposite surface 52 on the recording material conveyance direction upstream side of the fixing nip portion N, but the wax is unlikely to adhere to the opposite surface 53 on the downstream side. Therefore, in the case of the present exemplary embodiment, of the surfaces of the mold member 7c, the portions opposite the fixing belt 1 and the conveyance path 8a on a downstream side of a direction in which air is flown by the exhaust fan 60 of the fixing belt 1 may be covered. If a direction in which air is flown by the exhaust fan 60 is toward the recording material conveyance direction downstream side of the fixing nip portion N, the opposite surface 53 opposite the conveyance path 8b is to be covered with the coat material 54, without the opposite surface 52 being covered with the coat material 54. Other configurations and actions are similar to those in the above-described first exemplary embodiment.

In the above-described exemplary embodiments, the magnetic flux shielding plate 11 is not covered with the coat material 54, but there is a possibility that the wax also adheres to the magnetic flux shielding plate 11, and thus it is desirable to cover even the magnetic flux shielding plate 11 with the coat material 54. That is, of the surfaces of the magnetic flux shielding plate 11, a portion opposite the fixing belt 1 in a state where the magnetic flux shielding plate 11 has entered a space between a part of the mold member 7c and the fixing belt 1 is covered with the coat material 54. Accordingly, the adherence of the wax to the magnetic flux shielding plate 11 can be reduced.

Further, in the second exemplary embodiment, it is so configured as to cover the surfaces of the mold member 7c with coat material 54, as well as to perform exhaust by the exhaust fan 60 after completion of the image forming job. However, if exhaust by the exhaust fan 60 is sufficient, the coat material 54 may be omitted. That is, control is performed similar to the second exemplary embodiment, without covering the surfaces of the mold member 7c with the coat material 54. Specifically, the temperature of the fixing belt 1 is controlled, after completion of the image forming job, so that the surface temperature of the mold member 7c becomes equal to or higher than the vaporization temperature of the wax contained in the toner, and the exhaust fan 60 is driven for a predetermined time. In that case, owing to absence of the coat material 54, it is only necessary to adjust the surface temperature of the mold member 7c to reach a value equal to or higher than the vaporization temperature of the wax. The configurations apart from the ones relating to the coat material 54 are similar to those in the second exemplary embodiment.

Furthermore, in the above-described exemplary embodiments, the configuration for heating the fixing belt 1 using the induction heating device has been described, but a configuration for electromagnetic induction heating of the fixing rollers may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-195677 filed Sep. 6, 2012, which is hereby incorporated by reference herein in its entirety.

What is claimed is:

1. An image heating device comprising:
a rotatable heating member configured to heat a toner image formed on a sheet with a toner containing a wax component;
an exciting coil arranged outside the rotatable heating member and configured to generate a magnetic flux for subjecting the rotatable heating member to electromagnetic induction heating;
a holder configured to hold the exciting coil;
a magnetic flux suppression member configured to suppress a portion of a magnetic flux that acts on the rotatable heating member from the exciting coil; and
a movement mechanism configured to move the magnetic flux suppression member in a space between the rotatable heating member and the holder,
wherein the holder has a region opposite the magnetic flux suppression member, and the region is coated with fluorine-based resin.

2. The image heating device according to claim 1, wherein a contact angle of the region with water is 84° or greater.

3. The image heating device according to claim 1, wherein a contact angle of the region with water is 96° or greater.

4. The image heating device according to claim 1, wherein the region allows the magnetic flux suppression member to slidingly move relative thereto.

5. The image heating device according to claim 1, wherein the holder has an opposite region, opposite a conveyance path for the sheet, coated with the fluorine-based resin.

6. The image heating device according to claim 1, wherein the movement mechanism moves the magnetic flux suppression member reciprocally along a substantially longitudinal direction of the rotatable heating member.

7. The image heating device according to claim 6, wherein the movement mechanism moves the magnetic flux suppression member according to a width of the sheet.

8. An image heating device comprising:
a rotatable heating member configured to heat a toner image formed on a sheet with a toner containing a wax component;
an exciting coil arranged outside the rotatable heating member and configured to generate a magnetic flux for subjecting the rotatable heating member to electromagnetic induction heating;
a holder configured to hold the exciting coil;
a magnetic flux suppression member configured to suppress a portion of a magnetic flux that acts on the rotatable heating member from the exciting coil; and
a movement mechanism configured to move the magnetic flux suppression member in a space between the rotatable heating member and the holder,
wherein the holder has a region opposite the magnetic flux suppression member, and the region is coated with a coat material so a contact angle of the region with water is 84° or greater.

9. The image heating device according to claim 8, wherein a contact angle of the region with water is 96° or greater.

10. The image heating device according to claim 8, wherein the region allows the magnetic flux suppression member to slidingly move relative thereto.

11. The image heating device according to claim 8, wherein the holder has an opposite region, opposite a conveyance path for the sheet, coated with the coat material so a contact angle of the opposite region with water is 84° or greater.

12. The image heating device according to claim 8, wherein the holder has an opposite region, opposite a conveyance path for the sheet, coated with the coat material so that a contact angle of the opposite region with water is 96° or greater.

13. The image heating device according to claim 8, wherein the movement mechanism moves the magnetic flux suppression member reciprocally along a substantially longitudinal direction of the rotatable heating member.

14. The image heating device according to claim 13, wherein the movement mechanism moves the magnetic flux suppression member according to a width of the sheet.
